(19) United States
(12) Patent Application Publication
(10) Pub. No.: US 2011/0113185 A1
(43) Pub. Date: May 12, 2011

(54) MEMORY APPARATUS AND MEMORY CONTROLLER FOR ACCESSING NON-VOLATILE MEMORY

(76) Inventors: Kuo-Hua Yuan, Kaohsiung City (TW); Chao-Nan Chen, Taipei City (TW)

(21) Appl. No.: 12/650,572

(22) Filed: Dec. 31, 2009

(30) Foreign Application Priority Data
Nov. 12, 2009 (TW) 098138439

(51) Int. Cl. G06F 12/00; G06F 12/02

(52) U.S. Cl. 711/103; 711/E12.001; 711/E12.008

(57) ABSTRACT

A memory apparatus includes a non-volatile memory and a memory controller, where the memory controller is coupled to the non-volatile memory and is utilized for accessing the non-volatile memory, and the memory controller and the non-volatile memory are positioned in two independent chips, respectively. When external data is intended to be written into the non-volatile memory, the memory controller compresses the external data and stores compressed external data into the non-volatile memory.

### BACKGROUND OF THE INVENTION

1. Field of the Invention

The present invention relates to a memory device, and more particularly, to a memory device which compresses external data automatically, and a memory controller used for accessing a non-volatile memory.

2. Description of the Prior Art

In a flash memory, each data block has a limited erase-count/write-count; that is, when an erase-count/write-count of a data block exceeds a threshold value (e.g., 100,000), the data block may be damaged and the flash memory cannot be used further. Therefore, to prolong the service life of the flash memory, a wear-leveling technique or other similar algorithms can be used to arrange data to be distributed evenly across the flash memory. Although the above algorithms prolong the service life of the flash memory somewhat, how to further decrease the erase-count/write-count of the data block for prolonging the service life of the flash memory to a greater degree is an important topic in the field.

### SUMMARY OF THE INVENTION

It is therefore an objective of the present invention to provide a memory device which compresses external data automatically and a memory controller used for accessing a non-volatile memory, to solve the above-mentioned problem.

According to one embodiment of the present invention, a memory apparatus comprises a non-volatile memory and a memory controller, where the memory controller is coupled to the non-volatile memory and is utilized for accessing the non-volatile memory, and the memory controller and the non-volatile memory are positioned in two independent chips, respectively. When external data is intended to be written into the non-volatile memory, the memory controller compresses the external data and stores compressed external data into the non-volatile memory.

According to another embodiment of the present invention, a memory controller comprises a compress/decompress processor, where the memory controller is utilized for accessing a non-volatile memory, and the memory controller and the non-volatile memory are positioned in two independent chips, respectively. When external data is intended to be written into the non-volatile memory, the compress/decompress processor compresses the external data and stores compressed external data into the non-volatile memory.

According to another embodiment of the present invention, a memory apparatus comprises a non-volatile memory, a memory controller and a compress/decompress processor. The non-volatile memory is positioned in a first chip; the memory controller is coupled to the non-volatile memory and is utilized for accessing the non-volatile memory; and the compress/decompress processor is coupled to the memory controller, where the memory controller and the compress/decompress processor are positioned in a second chip different from the first chip. When external data is intended to be written into the non-volatile memory, the compress/decompress processor compresses the external data and stores compressed external data into the non-volatile memory.

According to the memory apparatus and the memory controller of the present invention, the external data is compressed before storing into the non-volatile memory, therefore, the erase-count/write-count of the data block of the flash memory can be reduced, and the service life of the flash memory is prolonged.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a memory apparatus according to a first embodiment of the present invention.

FIG. 2 is a memory apparatus according to a second embodiment of the present invention.

### DETAILED DESCRIPTION

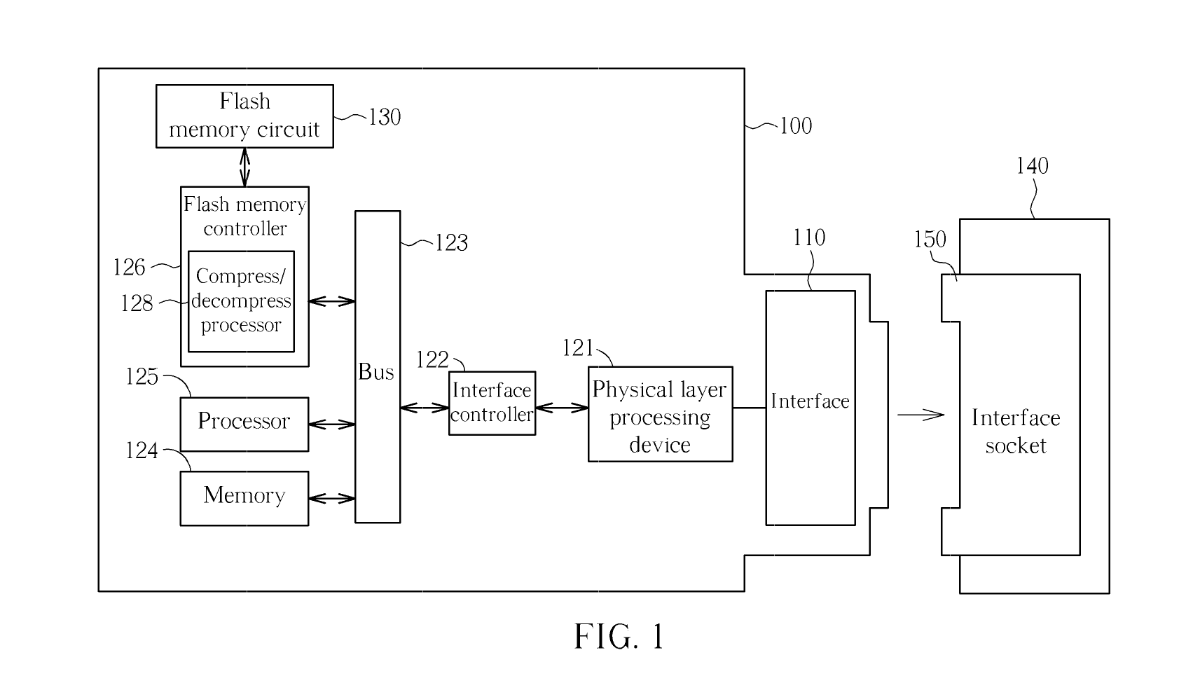

Please refer to FIG. 1. FIG. 1 is a memory apparatus 100 according to a first embodiment of the present invention. As shown in FIG. 1, the memory apparatus 100 includes an interface 110, a physical layer processing device 121, an interface controller 122, a bus 123, a memory 124, a processor 125, a flash memory controller 126 and a non-volatile memory (in this embodiment, a flash memory circuit 130 serves as the non-volatile memory), where the flash memory controller 126 includes a compress/decompress processor 128. In addition, the interface 110 can be one of a SATA (Serial Advanced Technology Attachment) interface, a USB (Universal Serial Bus) interface and a PCIE (Peripheral Component Interconnect Express) interface, or a combinational interface which includes at least two of the SATA interface, the USB interface and the PCIE interface. In addition, according to the standard of the interface 110, the physical layer processing device 121 can be one of SATA, USB, PCIE physical layer processing devices, or a combinational physical layer processing device which includes at least two of the SATA, USB and PCIE physical layer processing devices. The interface controller 122 can also be determined as one of SATA, USB, PCIE interface controllers, or a combinational interface controller which includes at least two of the SATA, USB and PCIE interface controllers according to the standard of the interface 110. In addition, the memory apparatus 100 can be a portable memory apparatus, and can be connected to an interface socket 150 of a computer host 140. Moreover, the flash memory circuit 130 is positioned in at least one first chip (i.e., the flash memory circuit 130 can be one or more chips), and the physical layer processing device 121, the interface controller 122, the bus 123, the memory 124, the processor 125, and the flash memory controller 126 are positioned in a second chip, where the second chip and the first chip are two independent chips.

When the memory apparatus 100 is connected to the computer host 140, and the computer host 140 intends to write data into the flash memory circuit 130, the data is transmitted to the flash memory controller 126 via the interface 110, the physical layer processing device 121, the interface controller 122 and the bus 123.

Then, when the flash memory controller 126 receives the external data from the bus 123, the compress/decompress processor 128 compresses the external data and stores the compressed external data into the flash memory circuit 130. In other words, what is stored into the flash memory circuit 130 is the compressed data, therefore the size of the data stored into the flash memory circuit 130 is reduced, and the service life of the flash memory circuit 130 is prolonged because of the reduced erase-counts/write-counts of data blocks of the flash memory circuit 130.

In detail, in the conventional memory apparatus, the external data is transmitted to the flash memory circuit via the flash memory controller. Assuming that the memory apparatus receives data whose size is 1K bytes and the memory apparatus processes one byte during one cycle, the conventional memory apparatus needs 1024 cycles to stores the data into the flash memory circuit, and the size of the data stored into the flash memory circuit is 1K bytes. Compared with the conventional memory apparatus, when the memory apparatus 100 of the present invention receives the data whose size is 1K bytes, the compress/decompress processor 128 of the flash memory controller 126 will compress the data to generate compressed data whose size is N bytes, where N<1024. Then, the N bytes compressed data are stored into the flash memory circuit 130 during N cycles.

It is noted that the compress/decompress processor 128 can compress all the data which is intended to be written into the flash memory circuit 130, and stores the compressed data into the flash memory circuit 130; or compresses a portion of data which is intended to be written into the flash memory circuit 130, and stores a portion of compressed data and a portion of un-compressed data into the flash memory circuit 130. These alternative designs should fall within the scope of the present invention.

In addition, in this embodiment, after the data is compressed, the compress/decompress processor 128 can store the compressed data into the flash memory circuit 130 directly, or can store the compressed data into the memory 124 in the first step, and then transmit the compressed data stored in the memory 124 to the flash memory circuit 130.

When the memory apparatus 100 is connected to the computer host 140, and the computer host 140 intends to read internal data stored in the flash memory circuit 130, the compress/decompress processor 128 decompresses the internal data, and outputs decompressed data to the computer host 140.

In detail, in the flow of the decompress operations, when the flash memory controller 126 receives a command which indicates that the computer host 140 intends to read the internal data stored in the flash memory circuit 130, assuming that the size of the internal data is N bytes and the size of the decompressed internal data is 1K bytes, the compress/decompress processor 128 will read and decompress the N bytes internal data in the flash memory circuit 130 and store the decompressed internal data into the memory 124 during N cycles, where the size of the compressed internal data stored in the memory 124 is 1K bytes. In addition, during the process of the internal data being decompressed and stored into the memory 124, the compress/decompress processor 128 dynamically accesses the memory 124, and transmits the decompressed internal data to the interface controller 122 via the bus 123, where the compress/decompress processor uses 1K cycles to transmit the decompressed internal data to the interface controller 122, and the size of the decompressed internal data is 1K bytes.

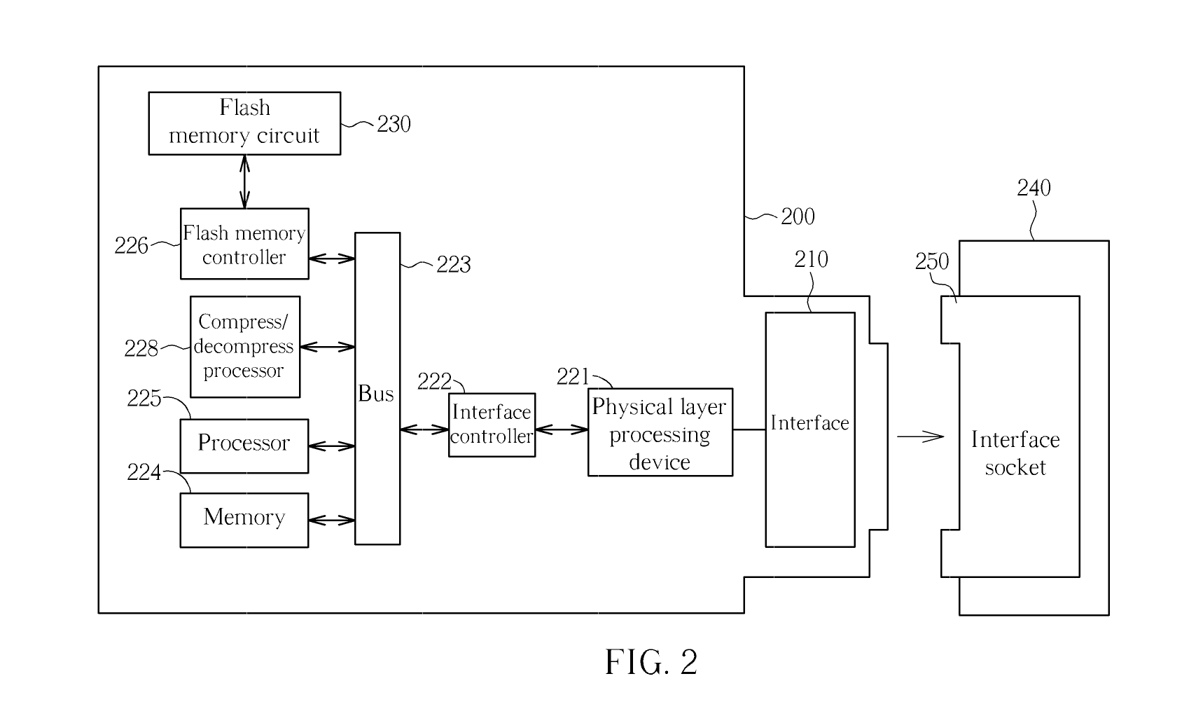

Please refer to FIG. 2. FIG. 2 is a memory apparatus 200 according to a second embodiment of the present invention. As shown in FIG. 2, the memory apparatus 200 includes an interface 210, a physical layer processing device 221, an interface controller 222, a bus 223, a memory 224, a processor 225, a flash memory controller 226, a compress/decompress processor 228 and a non-volatile memory (in this embodiment, a flash memory circuit 230 serves as the non-volatile memory). In addition, the interface 210 can be one of a SATA interface, USB interface and PCIE interface, or a combinational interface which includes at least two of the SATA interface, the USB interface and the PCIE interface. In addition, according to the standard of the interface 210, the physical layer processing device 221 can be one of SATA, USB, PCIE physical layer processing devices, or a combinational physical layer processing device which includes at least two of the SATA, USB and PCIE physical layer processing devices. The interface controller 222 can also be determined as one of SATA, USB, PCIE interface controllers, or a combinational interface controller which includes at least two of the SATA, USB and PCIE interface controllers according to the standard of the interface 210. In addition, the memory apparatus 200 can be a portable memory apparatus, and can be connected to an interface socket 250 of a computer host 240. Moreover, the flash memory circuit 230 is positioned in at least one first chip (i.e., the flash memory circuit 230 can be one or more chips), and the physical layer processing device 221, the interface controller 222, the bus 223, the memory 224, the processor 225, the flash memory controller 226 and the compress/decompress processor 228 are positioned in a second chip, where the second chip and the first chip are two independent chips, respectively.

The difference between the memory apparatus 200 and the memory apparatus 100 shown in FIG. 1 is that: the compress/decompress processor 128 of the memory apparatus 100 is implemented in the flash memory controller 126 (i.e., the compress/decompress processor 128 is a module of the flash memory controller 126), while the compress/decompress processor 228 of the memory apparatus 200 is implemented in the second chip independently (i.e., the compress/decompress processor 228 is independent of the flash memory controller 226). In addition, operations of the components of the memory apparatus 200 are similar to that of the memory apparatus 100 shown in FIG. 1. The person skilled in this art should understand the operations of the components of the memory apparatus 200 after reading the above descriptions about the memory apparatus 100. Therefore, further descriptions are omitted here.

Briefly summarized, in the memory apparatus and the memory controller of the present invention, the external data is compressed by the memory controller and then the compressed external data is stored into the flash memory circuit. Therefore, the erase-counts/write-counts of the data blocks of the flash memory circuit can be reduced, and the service life of the flash memory circuit is prolonged.

Those skilled in the art will readily observe that numerous modifications and alterations of the device and method may be made while retaining the teachings of the invention.

What is claimed is:

1. A memory apparatus, comprising:
a non-volatile memory; and
a memory controller, coupled to the non-volatile memory, for accessing the non-volatile memory, wherein the memory controller and the non-volatile memory are positioned in two independent chips, respectively;
wherein when specific external data is intended to be written into the non-volatile memory, the memory controller compresses the specific external data and stores compressed specific external data into the non-volatile memory.

2. The memory apparatus of claim 1, wherein the non-volatile memory is a flash memory.

3. The memory apparatus of claim 1, wherein the memory controller compresses all external data which are intended to be written into the non-volatile memory, and stores compressed external data into the non-volatile memory.

4. The memory apparatus of claim 1, wherein when a host intends to read internal data stored in the non-volatile memory, the memory controller decompresses the internal data and outputs decompressed internal data to the host.

5. A memory controller for accessing a non-volatile memory, wherein the memory controller and the non-volatile memory are positioned in two independent chips, respectively, and the memory controller comprises:
a compress/decompress processor, for compressing specific external data, and storing compressed specific external data into the non-volatile memory.

6. The memory controller of claim 5, wherein the non-volatile memory is a flash memory.

7. The memory controller of claim 5, wherein the compress/decompress processor compresses all external data which are intended to be written into the non-volatile memory, and stores compressed external data into the non-volatile memory.

8. The memory controller of claim 5, wherein when a host intends to read internal data stored in the non-volatile memory, the compress/decompress processor reads the internal data, decompresses the internal data and outputs decompressed internal data to the host.

9. A memory apparatus, comprising:
a non-volatile memory positioned in a first chip;
a memory controller, coupled to the non-volatile memory, for accessing the non-volatile memory; and
a compress/decompress processor, coupled to the memory controller, wherein the memory controller and the compress/decompress processor are positioned in a second chip, and the second chip is different from the first chip;
wherein when specific external data is intended to be written into the non-volatile memory, the compress/decompress processor compresses the specific external data, and stores compressed specific external data into the non-volatile memory via the memory controller.

10. The memory apparatus of claim 9, wherein the non-volatile memory is a flash memory.

11. The memory apparatus of claim 9, wherein the compress/decompress processor compresses all external data which are intended to be written into the non-volatile memory, and stores compressed external data into the non-volatile memory.

12. The memory apparatus of claim 9, wherein when a host intends to read internal data stored in the non-volatile memory, the compress/decompress processor reads the internal data, decompresses the internal data and outputs decompressed internal data to the host.
